(19) United States
(12) Patent Application Publication
(10) Pub. No.: US 2012/0164300 A1
(43) Pub. Date: Jun. 28, 2012

(54) Accelerated Aging of Wines and Sprits

(76) Inventor: Sarfaraz K. Niazi, Deerfield, IL (US)

(21) Appl. No.: 12/978,380

(22) Filed: Dec. 23, 2010

(51) Int. Cl. C12H 1/22; C12H 1/02

(52) U.S. Cl. 426/592; 99/277.2

(57) ABSTRACT

A method and a system for aging wines and spirits is disclosed using finely pulverized wood of less than 1 mm size and in such quantity to achieve equivalent aging in one-tenth to one-hundredth of the time required for traditional barrel aging and for instant aging prior to drinking.

### BACKGROUND

The wine industry is a $120 Billion business, the whisky industry is a $10 B+ dollar industry; the Scotch Whisky exports range about $5 Billion per year with the US being the largest importer of Scotch whisky. [Note: the official spelling of whisky is now without the “e” or Whiskey as it was done in the past to designate North American brands]. Worldwide, adults consume on average 5 liters of pure alcohol from beer, wine and spirits per year. The average alcohol consumption is highest in Europe, followed by the Americas and by Africa. It tends to increase with economic development. However, consumption remains low in some regions where the majority of the population is Muslim where most of alcohol is consumed discretely. Even countries like Saudi Arabia where alcohol is officially forbidden, almost 12 million liters of pure alcohol is consumed per year (http://www.who.int/substance_abuse/publications/en/saudi_arabia.pdf). With such trends, it is understandable why would there be a great interest in manufacturing high-end alcoholic beverages that yield higher profits. The higher end beverages are almost inevitably the aged products that have matured to a characteristic aroma and taste over a period of time, often years.

The aging of wine, and its ability to potentially improve in quality, distinguishes wine from most other consumable goods. While wine is perishable and capable of deteriorating, complex chemical reactions involving a wine's sugars, acids and phenolic compounds (such as tannins) can alter the aroma, color, mouth-feel and taste of the wine in a way that may be more pleasing to the taster. The ability of a wine to age is influenced by many factors including grape variety, vintage, viticultural practices, wine region and winemaking style. The condition that the wine is kept in after bottling can also influence how well a wine ages and may require significant time and financial investment.

The development of glass bottles with cork closure made it possible to more consistently age wine.

The Ancient Greeks and Romans were aware of the potential of aged wines. In Greece, early examples of dried “straw wines” were noted for their ability to age due to their high sugar contents. These wines were stored in sealed earthenware amphorae and kept for many years. In Rome, the most sought after wines—Falernian and Surrentine—were prized for their ability to age for decades. In the Book of Luke, it is noted “old wine” was valued over “new wine” (Luke 5:39). The Greek physician Galen wrote that the “taste” of aged wine was desirable and that heating or smoking the wine could accomplish this, though, in Galen's opinion, these artificially aged wines were not as healthy to consume as naturally aged wines [1].

Following the fall of the Roman Empire, appreciation for aged wine was virtually non-existent. Most of the wines produced in northern Europe were light bodied, pale in color and with low alcohol. These wines did not have much aging potential and barely lasted a few months before they rapidly deteriorated into vinegar. The older a wine got the cheaper its price became as merchants eagerly sought to rid themselves of aging wine. By the 16th century, sweeter and more alcoholic wines (like Malmsey and Sack) were being made in the Mediterranean and gaining attention for their aging ability. Similarly, Riesling from Germany with its combination of acidity and sugar were also demonstrating their ability to age. In 17th century two innovations occurred that radically changed the wine industry's view on aging. One was the development of the cork and bottle that allowed producers to package and store wine in a virtually airtight environment. The second was the growing popularity of fortifying wines such as Port, Madeira and Sherries. The added alcohol was found to act as a preservative, allowing wines to survive long sea voyages to England, The Americas and the East Indies. The English, in particular, were growing in their appreciation of aged wines like Port and Claret from Bordeaux. Demand for matured wines had a pronounced effect on the wine trade. For producers, the cost and space of storing barrels or bottles of wine was prohibitive so a merchant class evolved with warehouses and the finances to facilitate aging wines for a longer period of time. In regions like Bordeaux, Oporto and Burgundy, this situation dramatically increased the balance of power towards the merchant classes [1].

The Italian wine Tignanello is a blend of Sangiovese, Cabernet Sauvignon and Cabernet franc—varieties, which usually have aging potential.

Only a few wines have the ability to significantly improve with age. Master of Wine Jancis Robinson notes that only around the top 10% of all red wine and top 5% of all white wines can improve significantly enough with age to make drinking more enjoyable at 5 years of age than at 1 year of age. Additionally, Robinson estimates, only the top 1% of all wine has the ability to improve significantly after more than a decade. It is her belief that more wine is consumed too old, rather than too young, and that the great majority of wines start to lose appeal and fruitiness after 6 months in the bottle [2].

In general, wines with a low pH (such as Pinot Noir and Sangiovese) have a greater capability of aging. With red wines, a high level of flavor compounds, such as phenolics (most notably tannins), will increase the likelihood that a wine will be able to age. Wines with high levels of phenols include Cabernet Sauvignon, Nebbiolo and Syrah [1]. The white wines with the longest aging potential tend to be those with a high amount of extract and acidity. The acidity in white wines plays a similar role that tannins have with red wines in acting as a preservative. The process of making white wines, which includes little to no skin contact, means that white wines have a significantly lower amount of phenolic compounds, though barrel fermentation and oak aging can impart some phenols. Similarly, the minimal skin contact with rosé wine limits their aging potential [2].

After aging at the winery most wood-aged Ports, Sherries, Vins doux naturels, Vins de liqueur, basic level Ice wines and sparkling wines are bottled when the producer feels that they are ready to be consumed. These wines are ready to drink upon release and will not benefit much from aging. Vintage Ports and other bottled-aged Ports & Sherries will benefit from some additional aging, as can vintage Champagne [1]. In 2009, a 184-year-old bottle of Perrier-Jouët was opened and tasted, still drinkable, with notes of “truffles and caramel”, according to the experts [3].

Wines with little to no aging potential according to the guideline provided by Master of Wine Jancis Robinson include: German QBAs, Asti and Moscato Spumante, Rosé and blush wines like White Zinfandel, Branded wines like Yellow Tail, Mouton Cadet, European table wine, American jug and box wine, inexpensive varietals (with the possible exception of Cabernet Sauvignon), the majority of Vin de pays, all Nouveau wines, Vermouth, Basic Sherry, Ports; classified Bordeaux like this 1982 Château Ducru-Beaucaillou have aging potential [2].

Note that vintage, wine region and winemaking style can influence a wine's aging potential so Robinson's suggestion of years are very rough estimates of the most common examples of these wines: Botrytized wines (5-25 yrs), Chardonnay (2-6 yrs), Riesling (2-30 yrs), Hungarian Furmint (3-25 yrs), Loire Valley Chemn blanc (4-30 yrs), Hunter Valley Semillon (6-15 yrs), Cabernet Sauvignon (4-20 yrs), Merlot (2-10 yrs), Nebbiolo (4-20 yrs), Pinot noir (2-8 yrs), Sangiovese (2-8 yrs), Syrah (4-16 yrs), Zinfandel (2-6 yrs), Classified Bordeaux (8-25 yrs), Grand Cru Burgundy (8-25 yrs), Aglianico from Taurasi (4-15 yrs), Baga from Bairrada (4-8 yrs), Hungarian Kadarka (3-7 yrs), Bulgarian Melnik (3-7 yrs), Croatian Plavac Mali (4-8 yrs), Russian Saperavi (3-10 yrs), Madiran Tannat (4-12 yrs), Spanish Tempranillo (2-8 yrs), Greek Xynomavro (4-10 yrs) [2].

The ratio of sugars, acids and phenolics to water is a key determination of how well a wine can age. The less water in the grapes prior to harvest, the more likely the resulting wine will have some aging potential. Grape variety, climate, vintage and viticultural practice come into play here. Grape varieties with thicker skins, from a dry growing season where little irrigation was used and yields were kept low will have less water and a higher ratio of sugar, acids and phenolics. The process of making Eisweins, where water is removed from the grape during pressing as frozen ice crystals, has a similar effect of decreasing the amount of water and increasing aging potential [2].

In winemaking, the duration of maceration or skin contact will influence how much phenolic compounds are leached from skins into the wine. Pigmented tannins, anthocyanins, colloids, tannin-polysaccharides and tannin-proteins not only influence a wine's resulting color but also act as preservatives. During fermentation adjustment to a wine's acid levels can be made with wines with lower pH having more aging potential. Exposure to oak either during fermentation or after during barrel aging will introduce more phenolic compounds to the wines. Prior to bottling, excessive fining or filtering of the wine could strip the wine of some phenolic solids and may lessen a wine's ability to age [1].

The storage condition of the bottled wine will influence a wine's aging. Vibrations and heat fluctuations can hasten a wine's deterioration and cause adverse effect on the wines. In general, a wine has a greater potential to develop complexity and more aromatic bouquet if it is allowed to age slowly in a relatively cool environment. The lower the temperature, the more slowly a wine develops [1]. On average, the rate of chemical reactions in wine doubles with each 18° F. (8° C.) increase in temperature. Wine expert Karen MacNeil, recommends keeping wine intended for aging in a cool area with a constant temperature around 55° F. (13° C.). Wine can be stored at temperatures as high as 69° F. (20° C.) without long-term negative effect. Professor Cornelius Ough of the University of California, Davis believes that wine could be exposed to temperatures as high as 120° F. (49° C.) for a few hours and not be damaged. However, most experts believe that extreme temperature fluctuations (such as repeated transferring a wine from a warm room to a cool refrigerator) would be detrimental to the wine. However, the impact of temperature should be examined differentiating the impact during the phase when wine is stored in wooden barrels where both aromatic and non-aromatic components leach out of the wood and the chemical reactions that takes place during this storage period, both in the wood barrel and in the glass bottle. As it would be demonstrated later, keeping the temperature of wine at below 20° C. enhanced the extraction of both volatile and non-volatile components from wood and is thus the ideal temperature to age wines in wooden barrels. The ultra-violet rays of direct sunlight should also be avoided because of the free radicals that can develop in the wine and result in oxidation [4].

Wines packaged in large format bottles, such as magnums and 3 liter Jeroboams, seem to age more slowly than wines packaged in regular 750 ml bottles or half bottles. This may be because of the greater proportion of oxygen exposed to the wine during the bottle process. The advent of alternative wine closures to cork, such as screw caps and synthetic corks have opened up recent discussions on the aging potential of wines sealed with these alternative closures. Currently there are no conclusive results and the topic is the subject of ongoing research [1].

One of the short-term aging needs of wine is a period where the wine is considered “sick” due to the trauma and volatility of the bottling experience. During bottling some oxygen is exposed to the wine, causing a domino effect of chemical reaction with various components of the wine. The time it takes for the wine to settle down and have the oxygen fully dissolve and integrate with the wine is considered its period of “bottle shock”. During this time the wine could taste drastically different than it did prior to bottling or how it will taste after the wine has settled. While many modern bottling lines try to treat the wine as gently as possible and utilize inert gases to minimize the amount of oxygen exposure, all wine goes through some period of bottle shock. The length of this period will vary with each individual wine [2].

During the course of aging a wine may slip into a “dumb phase” where its aromas and flavors are very muted. In Bordeaux this phase is called the age ingrat or “difficult age” and is likened to a teenager going through adolescence. The cause or length of time that this “dumb phase” will last is not yet fully understood and seems to vary from bottle to bottle [4]. As vintage Port matures, sediments develop in the wines that are often left in the bottle when the wine is decanted.

As red wine ages, the harsh tannins of its youth gradually give way to a softer mouth feel. An inky dark color will eventually fade to a light brick red. These changes occur due to the complex chemical reactions of the phenolic compounds of the wine. In processes that begin during fermentation and continue after bottling, these compounds bind together and aggregate. Eventually these particles reach a certain size where they are too large to stay suspended in the solution and precipitate out. The presence of visible sediment in a bottle will usually indicate a mature wine. The resulting wine, with this loss of tannins and pigment, will have a paler color and taste softer, less astringent. The sediment, while harmless, can have an unpleasant taste and is often separated from the wine by decanting [2].

During the aging process, the perception of a wine's acidity may change even though the total measurable amount of acidity is more or less constant throughout a wine's life. This is due to the esterification of the acids, combining with alcohols in complex array to form esters. In addition to making a wine taste less acidic, these esters introduce a range of possible aromas. Eventually the wine may age to a point where other components of the wine (such as a tannins and fruit) are less noticeable, which will then bring back a heightened perception of wine acidity.

Other chemical processes that occur during aging include the hydrolysis of flavor precursors, which detach themselves from glucose molecules and introduce new flavor notes in the older wine and aldehydes become oxidized. The interaction of certain phenolics develops what is known as tertiary aromas, which are different from the primary aromas that are derived from the grape and during fermentation [1]. Aged Malmsey Madeira shows the color change that white wines goes through as they age.

As a wine starts to mature, its bouquet will become more developed and multi-layered. While a taster may be able to pick out a few fruit notes in a young wine, a more complex wine will have several distinct fruit, floral, earthy, mineral and oak derived notes. The lingering finish of a wine will lengthen. Eventually the wine will reach a point of maturity, when it is said to be at its “peak”. This is the point when the wine has the maximum amount of complexity, most pleasing mouth feel and softening of tannins and has not yet started to decay. When this point will occur is not yet predictable and can vary from bottle to bottle. If a wine is aged for too long, it will start to descend into decrepitude where the fruit tastes hollow and weak while the wine's acidity becomes dominant [1].

The Fischer-Speier esterification is a special type of esterification by refluxing a carboxylic acid and an alcohol in the presence of an acid catalyst. The natural esterification that takes place in wines and other alcoholic beverages during the aging process is an example of acid-catalyzed esterification. Over time, the acidity of the acetic acid and tannins in an aging wine will catalytically protonate other organic acids (including acetic acid itself), encouraging ethanol to react as a nucleophile. As a result, ethyl acetate—the ester of ethanol and acetic acid—is the most abundant ester in wines. Other combinations of organic alcohols (such as phenol-containing compounds) and organic acids lead to a variety of different esters in wines, contributing to their different flavors, smells and tastes. Of course, when compared to sulfuric acid conditions, the acid conditions in a wine are mild, so yield is low (often in tenths or hundredths of a percentage point by volume) and take years for ester to accumulate.

There is a long history of man using artificial means to try to accelerate the natural aging process. In Ancient Rome a smoke chamber known as a fumarium was used to enhance the flavor of wine through artificial aging. Amphorae were placed in the chamber, which was built on top of a heated hearth, in order to impart a smoky flavor in the wine that also seemed to sharpen the acidity. The wine would sometimes come out of the fumarium with a paler color just like aged wine [5].

Modern winemaking techniques like micro-oxygenation can have the side effect of artificially aging the wine. In the production of Madeira and Rancio wines, the wines are deliberately exposed to excessive temperatures to accelerate the maturation of the wine. Other techniques used to artificially age wine (with inconclusive results on their effectiveness) include shaking the wine, exposing it to radiation, magnetism or ultra-sonic waves [1]. More recently, experiments with artificial aging through high-voltage electricity have produced results above the remaining techniques, as assessed by a panel of wine tasters [6].

Coates Law of Maturity is a principle used in wine tasting relating to the aging ability of wine. Developed by the British Master of Wine, Clive Coates, the principle states that a wine will remain at its peak (or optimal) drinking quality for duration of time that is equal to the time of maturation required to reach its optimal quality. During the evolution (aging) of a wine certain flavors, aromas and textures appear and fade. Rather than developing and fading in unison, these traits each operate on a unique evolutionary path and time line. The principle allows for the subjectivity of individual tastes because it follows the logic that positive traits that appeal to one particular wine taster will continue to persist along the principle's guideline while for another taster these traits might not be positive and therefore not applicable to the guideline. Wine expert Tom Stevenson has noted that there is logic in Coates' principle and that he has yet to encounter an anomaly or wine that debunks it [7]. An example of the principle in practice would be a wine that someone discovers at 10 years of age. The drinker may find this wine very pleasing in texture, aroma and mouth feel. Under the Coates Law of Maturity the wine will continue to be drinking at an optimal level for that drinker until it has reached 20 years of age at which time those positive traits that the drinker perceives will start to fade [7].

Ullage (from the French ouillage) is a winemaking term that has several meanings but most commonly refers to the headspace of air between wine and the top of the container that it is in. It can also refer to the process of evaporation that creates the headspace itself or it can be used as a past tense verb to describe a wine barrel or bottle that has gone through the evaporation process (to be ullaged, etc). The headspace of air is a mixture mostly of alcohol and water vapors with carbon dioxide that is a by-product of the fermentation process. In containers that are not completely air tight (such as an oak wine barrel or a cork-stopper wine bottle), oxygen can also seep into this space. While some oxygen is beneficial to the aging process of wine, excessive amounts can lead to oxidation and other various wine faults. This is why wine in the barrels is regularly “topped up” and refilled to the top with wine in order to minimize the headspace. In the bottle, the ullage or “fill level” of the wine can be an important indicator of the kind of care and storage conditions that the wine was kept in. After-market resellers and wine auction houses will often inspect the ullage levels of older vintages to determine the potential quality and value of wine [8].

The “red band” seen on many wine barrels is from wine spill. Some of this spillage comes from the topping off process when the bung is reinserted into the barrel.

At the winery, the natural process of evaporation creates ullage in the barrel by causing some of the alcohol and water particles to escape as vapors—a loss sometimes referred to as the “angel's share”. If the wine is in a container that is not completely airtight, these vapor molecules (along with carbon dioxide) will diffuse out of the container through openings in the wood and around the bung and be replaced with oxygen molecules. While some oxygen is beneficial in the maturation and breakdown of some phenolic compounds such as tannin, excessive amounts of oxygen can interact with acetobacter present in the wine and start the process of turning the wine into vinegar. To prevent this possible oxidation and spoilage wineries will regularly “top up” the barrels by replacing the lost liquid with new wine [8].

The exact method and timing of topping up a wine barrel is determined by the individual wineries and can depend on the type of wine or grape variety that is being produced. A barrel can be topped off anywhere from once a week to every month and a half. The position of the barrel can affect the speed and degree of evaporation and the need for topping up. If the barrel is sitting with its bunghole on top, aeration and evaporation occurs more quickly. If the barrel is turned to the side in the bung over position, the bung is kept moist with the wine and aeration occurs at a slower pace. The wine that is replaced during the topping up is usually the same wine taken from another smaller container (such as a carboy) with the barrel filled to the very top to where the reinsertion of the bung causes some spillage [8].

The ullage level of a wine bottle is sometime described as the “fill level”. This describes the space between the wine and the bottom of the cork. During the bottling process, most wineries strive to have an initial ullage level of between 0.2-0.4 inches (5-10 mm). As a cork is not a completely airtight sealant, some wine is lost through the process of evaporation and diffusion. As a wine ages in the bottle, the amount of ullage will continued to increase unless a wine is opened, topped up and re-corked. If the wine is stored on its side, in contact with the cork, some wine will also be lost by absorption into the cork with longer corks having the potential to absorb more wine (and thus create more ullage) than shorter corks [8].

Generally the greater the amount of ullage, the more potential that the wine has been exposed to harmful levels of oxidation. This is why auction houses and retailer of mature wines pay close attention to the ullage levels in determining the resale value of the wine. The ullage level can also give insight as to the type of care and storage condition that the wine was kept in. Wines that have been kept at ambient humidity levels and in temperatures between 50-59° F. (10-15° C.) will experience evaporation and diffusion at a slower rate than wine kept in lesser conditions and will thus have a lower ullage levels. In certain wines, such as Bordeauxs, ullage levels can be of a greater concern than other wines, such as Ports, Sauternes and very tannic Barolos since some oxidation can be beneficial to the wine [8].

There are standard descriptions used by wine merchants and auction houses for the fill levels (ullage levels) of wine. The fill levels descriptions are different for Bordeaux and Burgundy wines due to the different shape of the bottles from those two regions [9, 10].

The use of oak in wine plays a significant role in winemaking and can have a profound effect on the resulting wine, affecting the color, flavor, tannin profile and texture of the wine. Oak can come into contact with wine in the form of a barrel during the fermentation or aging periods. It can be introduced to the wine in the form of free-floating oak chips or as wood staves (or sticks) added to wine in a fermentation vessel like stainless steel. Oak introduced in the form of a wine barrel can impart other qualities to the wine through the process of evaporation and low-level exposure to oxygen [11].

In early wine history, the amphora was the vessel of choice for the storage and transportation of wine. Due to the perishable nature of wood material it is difficult to trace the usage of barrels in history. The Greek historian Herodotus noted that ancient Mesopotamians used barrels made of palm wood to transport wine along the Euphrates. Palm is a difficult material to bend and fashion into barrels, however, and wine merchants in different regions experimented with different wood styles to find a better wood source [12]. The use of oak has been prevalent in winemaking for at least two millennia, first coming into widespread use during the Roman empire. In time, winemakers discovered that beyond just storage convenience that wine kept in oak barrels took on properties that improved the wine by making it softer and in some cases better tasting [13]. Robert Mondavi is credited with expanding the knowledge of winemakers in the United States about the different types of oak and barrel styles through his experimentation in the 1960s & 1970s [14].

The effect of oak aging on red wine color: the above samples are both Penedès region Cabernet Sauvignon varietals; on the left, a two-year-old cosecha; on the right a six-year-old crianza. As the wine matures, its color shifts from deep purple or crimson to a lighter brick red and takes on a more graduated appearance in the glass.

The porous nature of an oak barrel allows some levels of evaporation and oxygenation to occur in wine but typically not at levels that would cause oxidation or spoilage of the wine. In a year, the typical 59-gallon barrel can lose anywhere from 5½ to 6½ gallons of wine through the course of evaporation. This evaporation (of mostly alcohol and water) allows the wine to concentrate its flavor and aroma compounds. Small amounts of oxygen are allowed to pass through the barrel and acts as a softening agent upon the tannins of the wine [13].

The chemical properties of oak itself can have a profound effect on the wine.

Phenols within the wood interact with the wine to produce vanilla type flavors and can give the impression of tea notes or sweetness. The degree of “toast” on the barrel can also impart different properties affecting the tannin levels of the wine as well as the aggressive wood flavors [15]. The hydrolyzable tannins present in wood, known as ellagitannins, are derived from lignin structures in the wood.

They help protect the wine from oxidation and reduction [16].

Wines can be barrel fermented in oak or they can be placed in oak after fermentation for a period of aging or maturation. Wine that is matured in oak receives more of the oak flavors and properties than wine that is fermented in oak. This is because yeast cells interact with and “latch on” to the oak components. When the dead yeast cells are removed from the wine as lees some of these oak properties go with them [17]. Characteristics of white wines that are fermented in oak include a pale color with an extra silky texture. White wines that are fermented in steel and then matured in oak will have a darker coloring due to the heavy phenolic compounds that are still present [8]. Flavor notes that are common descriptions of wines exposed to oak include caramel, cream, smoke, spice and vanilla. Chardonnay is a variety that has very distinct flavor profiles when fermented in oak that include coconut, cinnamon and cloves notes. The “toastiness” of the barrel can bring out varying degrees of mocha and toffee notes in red wine [19].

The length of time that a wine spends in the barrel is dependent on the varietal and style of wine that the winemaker wishes to make. The majority of oak flavoring is imparted in the first few months that the wine is in contact with oak but a longer term exposure can affect the wine through the light aeration that the barrel allows which helps to precipitate the phenolic compounds and quickens the aging process of the wine [8]. New World Pinot noir may spend less than a year in oak. Premium Cabernet Sauvignon may spend two years. The very tannic Nebbiolo grape may spend four or more years in oak. High-end Rioja producers will sometimes age their wines up to ten years in American oak to get a desired earthy, vanilla character [17].

The species of oak typically used for American oak production is the Quercus alba which is a white oak species that is characterized by its relatively fast growth, wider grains and lower wood tannins. It is found in most of the Eastern United States as well as Missouri, Minnesota and Wisconsin where many wine barrels are from. In Oregon the Quercus garryana white oak has started to gain usage due to its closer similarities to European oak. In France, the main winemaking oak species is the Quercus petraea, which is known for tighter grain, high tannins and lower aromatics than its American oak counterpart. French oak typically comes from one or more primary forests: Allier, Limousin, Nevers, Troncais and Vosges. The wood from each of these forests has slightly different characteristics. Many winemakers utilize barrels made from different cooperages, regions and degrees of toasting in blending their wines to enhance the complexity of the resulting wine [20].

The tighter grain of French oak allows for a more gradual integration of flavors in the wine.

Italian winemakers have had a long history of using Slavonian oak from the Quercus robur, which is known for its tight grain, low aromatics and medium level tannins. Prior to the Russian Revolution, Quercus petraea oak from the Baltic States was the most highly sought after wood for French winemaking [21]. Today French winemakers are exploring Russian oak from the Adygey region along the Black Sea as a cheaper alternative to French oak [22]. Canadian wineries have been experimenting with the use of Canadian oak, which proponents describe as a middle ground between American and French oak even though it is the same species as American oak [23].

Oak trees are typically between 80-120 years old prior to harvesting with the ideal conditions being a cool climate in a dense forest region that gives the trees opportunity to mature slowly and develop a tighter grain. Typically one tree can provide enough wood for two 59-gallon barrels. The trees are typically harvested in the winter months when there is less sap in the trunk [21].

American oak tends to be more intensely flavored than French oak with more sweet and vanilla overtones due to the American oak having two to four times as many lactones [29]. Winemakers that prefer American oak typically use them for bold, powerful reds or warm climate Chardonnays. Besides being derived from different species, a major difference between American and French comes from the preparation of the oak. The tighter grain and less watertight nature of French oak encourages coopers to split the wood along the grain rather than saw. French oak is then traditionally aged or “seasoned” for at least two years whereas American coopers will often use a kiln-dry method to season the wood [21]. Long periods of outdoors season have a mellowing effect on the oak that kiln-dry methods have difficulties replicating [29]. The sawing, rather than splitting, of American oak also enhances the differences between the two styles due to the rupture of the xylem cells in the wood which releases many of the vanillin aromatics and lactones responsible for characteristics like the coconut notes [24].

Wine barrels, especially those made of oak, have long been used as containers in which wine is aged. Aging in oak typically imparts desirable vanilla, butter and spice flavors to wine. The size of the barrel plays a large role in determining the effects of oak on the wine by dictating the ratio of surface area to volume of wine with smaller containers having a larger impact. The most common barrels are the Bordeaux barriques style, which hold 59 gallons (225 liters) followed by the Burgundy style barrel, which hold 60 gallons (228 liters). Some New World wine makers use the large hogshead 79-gallon (300 liter) size [28].

New barrels impart more flavors than do previously used barrels. Over time many of the oak properties get “leached” out of the barrel with layers of natural deposits left from the wine building up on the wood to where after 3 to 5 vintages there may be little or no oak flavors imparted on the wine [25]. The cost of barrels varies due to the supply and demand market economy and can change with different features that a cooperage may offer. As of late 2007 the price for a standard American oak barrel was $270 USD, French oak $600 USD, and Eastern European $480 USD [25]. More recently, standard French Oak barrel sells for around $740 (http://www.worldcooperage.com/price-list). Due to the expense of barrels, several techniques have been devised in an attempt to save money. One is to shave the inside of used barrels and insert new thin inner staves that have been toasted [26].

Barrels are constructed in cooperages. The traditional method of European coopers has been to hand split the oak into staves (or strips) along the grain. After the oak is split it is allowed to “season” or dry outdoors while exposed to the elements.

This process can take anywhere from 10 to 36 months during which time the harshest tannins from the wood are leached out. These tannins are visible as dark gray and black residue left on the ground once the staves are removed. The longer the wood is allowed to season the softer the potential wine stored in the barrels may be but this can add substantially to the cost of the barrel. In some American cooperage the wood is dried in a kiln instead of outdoor seasoning. While this method is much faster, it doesn't soften the tannins quite as much as outdoors seasoning [27].

The staves are then heated, traditionally over an open fire, and when pliable are bent into the shape of the desired barrel and held together with iron rings. Instead of fire, a cooper may use steam to heat up the staves but this tends to impart less “toastiness” and complexity to the resulting wine. Following the traditional, hand worked style a cooper is typically able to construct one barrel in a day's time.

Winemakers can order barrels with the wood on the inside of the barrel having been lightly charred or “toasted” with fire, medium toasted, or heavily toasted [27]. Typically the “lighter” the toasting the more oak flavor and tannins that are imparted. Heavy toast or “charred” which is typical treatment of barrels in Burgundy wine have an added dimension from the char that medium or light toasted barrels do not impart [28]. Heavy toasting dramatically reduces the coconut note lactones, even in American oak, but create a high carbon content that may reduce the coloring of some wines. During the process of toasting, the furanic aldehydes in the wood reach a higher level of concentration. This produces the “roasted” aroma in the wine. The toasting also enhances the presences of vanillin and the phenol eugenol, which creates smoky and spicy notes that in some wines are similar to the aromatics of oil of cloves [24].

Although oak barrels have long been used by winemakers, many wineries now use oak wood chips for aging wine more quickly and also adding desired woody aromas along with butter and vanilla flavors. Oak chips can be added during fermentation or during aging. In the latter case, they are generally placed into fabric sacks and placed into the aging wine. The diversity of chips available gives winemakers numerous options. Oak chips have the benefit of imparting intense oak flavoring in a matter of weeks while traditional oak barrels would need a year or more to convey similar intensity. Critics claim that the oak flavoring from chips tend to be one-dimensional and skewed towards the vanilla extract with the wines still lacking some of the physical benefits that barrel oak imparts [16]. The use of oak powder is also less common than chips, although they are a very practical alternative if oak character is to be introduced during fermentation. Oak planks or staves are sometimes used, either during fermentation or aging. Wines made from these barrel alternatives typically do not age as well as wines that are matured in barrels [8]. Improvements in micro-oxygenation have allowed winemakers to better mimic the gentle aeration of oak barrels in stainless steel tanks with oak chips [28].

Prior to 2006, the practice of using oak chips was outlawed in the European Union [19]. In 1999, the Bordeaux court of appeals fined four wineries, including third growth Chateau Giscours, more than $13,000 USD for the use of oak chips in their wine [30].

Throughout history other wood types, including chestnut, pine, redwood, and acacia, have been used in crafting winemaking vessels, particularly large fermentation vats. However none of these wood types possess the compatibility with wine that oak has demonstrated in combining its water tight, yet slightly porous, storage capabilities with the unique flavor and texture characteristic that it can impart to the wine that it is in contact with [31]. Chestnut is very high in tannins and is too porous as a storage barrel and must be coated with paraffin to prevent excessive wine loss through evaporation. Redwood is too rigid to bend into the smaller barrel shapes and imparts an unpleasant flavor. Acacia imparts a yellow tint to the wine. Other hardwoods like apple and cherry wood have an off-putting smell [32]. Austrian winemakers have a history of using Acacia barrels. Historically, chestnut was used by Beaujolais, Italian and Portuguese wine-makers [33]. Some Rhone wine-makers still use paraffin coated chestnut barrels but the coating minimizes any effect from the wood making its function similar to a neutral concrete vessel. In Chile there are traditions for using barrel made of rauli wood but it is beginning to fall out of favor due to the musky scent it imparts on wine [34].

While many attempts have been made in the past to accelerate the aging of alcoholic beverages, there remains an unmet need to invent a process or a system that would allow aging to proceed extremely fast without modifying the natural process of aging that imparts unique character to alcoholic beverages.

### REFERENCES

1. Robinson (ed.). The Oxford Companion to Wine, Third Edition, pg. 5-7. Oxford University Press, 2006. ISBN 0198609906.
2. J. Robinson Jancis Robinson's Wine Course Third Edition pg 39-41 Abbeville Press 2003 ISBN 0789208830
3. Julian Joyce (20 Mar. 2009). “World's oldest champagne opened”. BBC News Online.
4. MacNeil The Wine Bible pg 79-82 Workman Publishing 2001 ISBN 1563054345
5. Hugh Johnson, Vintage: The Story of Wine pg 72. Simon and Schuster 1989.
6. Stephanie Pain (17 Dec. 2008). “How to make cheap wine taste like a fine vintage”. New Scientist (2687).
7. T. Stevenson “The Sotheby's Wine Encyclopedia” pg 631 Dorling Kindersley 2005 ISBN 0756613248
8. J. Robinson (Ed) “The Oxford Companion to Wine” Third Edition pg 270, 702 & 718 Oxford University Press 2006 ISBN 0198609906
9. Wine-Searcher “Bottle Fill Level Abbreviations—http://www.wine-searcher.com/fill-levellml”
10. G. Harding “A Wine Miscellany” pg 33, Clarkson Potter Publishing, New York 2005 ISBN 0307346358
11. J. Robinson Jancis Robinson's Wine Course Third Edition pg 91-93 Abbeville Press 2003 ISBN 0789208830
12. H. Johnson Vintage: The Story of Wine pg 25-26 Simon and Schuster 1989 ISBN 0671687026
13. K. MacNeil The Wine Bible pg 40 Workman Publishing 2001 ISBN 1563054345
14. H. Johnson Vintage: The Story of Wine pg 453 Simon and Schuster 1989 ISBN 0671687026
15. K. MacNeil The Wine Bible pg 41 Workman Publishing 2001 ISBN 1563054345
16. J. Robinson (ed) “The Oxford Companion to Wine” Third Edition pg 492 Oxford University Press 2006 ISBN 0198609906
17. K. MacNeil The Wine Bible pg 45 Workman Publishing 2001 ISBN 1563054345
18. J. Robinson Jancis Robinson's Wine Course Third Edition pg 93 Abbeville Press 2003 ISBN 0789208830
19. Sogg “White Wines, New Barrels: The taste of new oak gains favor worldwide” Wine Spectator Jul. 31, 2001
20. Stevenson “The Sotheby's Wine Encyclopedia” pg 33-34 Dorling Kindersley 2005 ISBN 0756613248
21. J. Robinson Jancis Robinson's Wine Course Third Edition pg 92 Abbeville Press 2003 ISBN 0789208830
23. D. Sogg “French Barrelmaker Turns to Russian Oak” Wine Spectator Oct. 15, 2002
24. K. Ebjich “Canadian Oak Barrels Get the Nod From Winemakers” Wine Spectator Nov. 11, 2003
25. T. Stevenson “The Sotheby's Wine Encyclopedia” pg 33 Dorling Kindersley 2005 ISBN 0756613248
26. World Cooperage Product Information
27. Sogg “Oak Flavorings” Wine Spectator Sep. 20, 2002
28. MacNeil The Wine Bible pg 42-43 Workman Publishing 2001 ISBN 1563054345
29. J. Robinson (ed) “The Oxford Companion to Wine” Third Edition pg 491 Oxford University Press 2006 ISBN 0198609906
30. Jancis Robinson (May 4, 2006). “Giant ‘teabags’ of oak chips now legal in Europe”. San Francisco Chronicle.
31. J. Mann “Bordeaux Chateaus Fined for Use of Wood Chips” Wine Spectator Nov. 29, 1999
32. J. Robinson Jancis Robinson's Wine Course Third Edition pg 91 Abbeville Press 2003 ISBN 0789208830
33. J. Ross “Rethinking American vs. French oak” Wines & Vines Nov. 1, 1992
34. J. Robinson (ed) “The Oxford Companion to Wine” Third Edition pg 775 Oxford University Press 2006 ISBN 0198609906
35. T. Stevenson “The Sotheby's Wine Encyclopedia” pg 32 Dorling Kindersley 2005 ISBN 0756613248

### SUMMARY OF INVENTION

The instant invention relates generally to a system of accelerating the aging of wine and/or spirits. Conventionally, wines and spirits are aged in wood barrels keeping them in these barrels for long time, even for years, to achieve certain taste, smell and character. The cost of aging spirits and wines contributes to the largest fraction of total production cost and creates strategic problems of handing large volumes as the demand for wines and spirits increases and since the manufacturer must predict future requirements to allow appropriate time for the aging. This almost always creates situations where the manufacturer is In earlier days, wine making was practiced in very low volume by a few masters caught short or long on market needs, who handed the craft from generation to generation. Recently, however, the wine business has burgeoned into a multibillion-dollar industry, which stretches around the world. New vineyards, such as Napa Valley and Australia, have joined the traditional ranks of those in Italy, France, Spain, Portugal, and the like. Even though the demand for this commodity has increased multifold, the process by which the wine is made has remained pretty much the same. Thus, wineries have been forced to increase such things as vat volume, aging capacity, and the like. A limiting factor in further increasing production is the aging time.

In the making of many wines and spirits it is usual to age the wine or spirits in, for example, wooden barrels. “Barrel aging” is a centuries-old practice to improve the characteristics, such as taste and mellowness of wine. Certain aging techniques are used to impart a flavor and “soften” the wine. Usually, for quality wines, the barrels are made of new oak. In recent years, synthetic barrels made of materials having limited porosity have been used and oak wood chips added for flavor. The drawback of barrel aging is the time that it takes to naturally age the fermented beverage.

The aging process, although complex, is thought to involve oxygen-induced chemical reactions, including polymerization of short chain phenols as well as partitioning of aromatic components of the wood barrel into wine. During the barrel ageing process, water and alcohol are thought to diffuse out through the semi-permeable walls of the barrel and oxygen from the atmosphere diffuses in. The chemical reaction occurs in a region near the interface of the inner barrel wall and the wine called the Reaction Region. As a result, a concentration gradient of the products builds near the barrel wall known as the Reaction Barrier. The rate of reaction (ageing) is thought to be dependent on the concentration of the reactants at the Reaction Region and the removal of the products, which form the Reaction Barrier. When the Reaction Barrier is allowed to create a boundary, it inhibits fresh wine from reaching the Reaction Region and the aging reaction is slowed.

The replenishing of fresh wine through the Reaction Barrier layer has traditionally been accomplished only by diffusion or natural convection within the barrel.

The usual practice for barrel ageing is to leave the barrels in racks undisturbed except for periodic sampling or topping off as evaporation of the water and alcohol depletes the liquid. In some wineries the barrels are turned to provide some agitation or mixing of the body of the wine. This has little effect on the convection boundary layer, but favorably affects the diffusion profiles of the reactants in the ageing process. Because the effect on ageing rate is small and the effort is large, the turning of barrels is not done by the majority of winemakers.

While exposure to oxygen during racking and ageing in the barrel can be of benefit to the wine, excess oxygen can be deleterious and “sour” the wine. Thus, wines that are “corked” or have “turned” are examples of excess oxidation. Once a bottle of wine has been opened for some time, or if oxygen has seeped past a faulty cork, the oxidized wine will taste “off” and eventually sour. Therefore, accelerating aging by introduction of oxygen has to be controlled to prevent deleterious excessive oxidation.

Therefore, it would be advantageous to have a method for increasing the aging process without altering the natural balance of partitioning of aromatic compounds and phenol polymerization reactions that would accelerate the reactions but not alter the equilibrium state of partitioning. This invention would thus be significantly different and unobvious from such invention as extraction oak wood and adding to wine as described in the U.S. Pat. No. 6,132,788 to Zimlich and U.S. Pat. No. 5,102,675 to Howell or using wood chips with solvents and heat to improve the taste as taught in US Patent Application 2003/0008036 of Huige; this was application was rejected and later abandoned. All of these approaches reported alter the natural balance of aging and are thus not a good substitute of re-creating the fine aging process.

It is noteworthy that the aging of wine continues even in the glass bottle as long as the required quantity and type of components have been extracted from the wood. The method described therefore expedites that part of aging wherein long-term contact with wood surface is required to achieve a state of equilibrium between the wine and the type of wood barrel in which the wine is stored.

The foregoing discussion pertained to wines but the same argument can be applied to aging of whisky, except that once bottled, whisky stops aging. A variety of methods are used to age whisky. Whisky lactone (3-methyl-4-octanolide) is found in all types of oak. This lactone has a strong coconut aroma. Whisky lactone is also known as quercus lactone. Commercially charred oaks are rich in phenolic compounds. One study identified 40 different phenolic compounds. The coumarin scopoletin is present in whisky, with the highest level reported in Bourbon whiskey. The invention disclosed here can be applied to whisky aging as well wherein the desired type of wood, processed or unprocessed, can be used to expedite the aging of whisky.

Additional value can be gained by adjusting the temperature of wine or whisky to obtain maximum partitioning of the aromatic and non-aromatic components found in wood.

The commercial impact of the invention disclosed here is remarkable. Most desired whiskies are aged for about 10-18 years and are sold at a premium price.

The manufacturer faces a rather unusual problem in projecting the demand for its product a decade later; short supplies would cause the distiller to lose business and excessive supplies would add substantial cost to the business because the stock on hand under aging is a long-term financial liability. The invention described here makes it possible for the distiller to respond to various demands of its brands almost instantly without having the need to long-term storage of whisky. The invention disclosed here thus reduces the cost of production substantially.

The foregoing descriptions of specific embodiments of the present invention are presented for the purposes of illustration and description. They are not intended to be exhaustive or to limit the invention to the precise forms disclosed; obviously many modifications and variations are possible in view of the above teachings.

The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

In one embodiment, the present invention is a novel system of aging alcoholic beverages wherein the process of aging is carried out naturally; in another embodiment, the present invention is a method of accelerating the aging by increasing the surface area of wood available for the transfer or aromatic and non-aromatic components of wood; yet, in another embodiment, the present invention allows accelerated aging ranging 10 to 100 times faster or even higher, a method that had never been reported before.

### DETAILS OF INVENTION

It has now been discovered that a plausible method of naturally aging alcoholic beverages would involve a method whereby the rate of material transfer between wood and wine is enhanced but not the equilibrium state; this is accomplished in this invention by using ground wood providing a surface area.

The inner surface area of a wood barrel (approximating it to a cylinder) is approximately given by the following equation:

A=2πr²+2πrh=2πr(r+h).

A standard wine barrel has a height of about 95 cm and radius of about 34 cm giving the area of barrel being equal to: 28,600 cm². Realizing that about 223 L of wine is stored in each barrel, this gives the total surface area available for each mL of wine to be about 0.13 square-centimeter.

The volume of a spherical object is given by

$$V = \frac{4}{3} π {r}^{3}$$

The surface area of a spherical object is given by following equation:

A=4πr²

A sphere of radius of 100 micron or 0.01 cm gives a surface area of 0.00126 cm² and a volume of 0.0000042 cm² and weight of 0.00000315 g (density of wood taken as 0.75 g/cm³). To get the same area as found in a barrel, we need a total of 22.6 million spheres or a total of about 71 g of wood. This is compared to 54,000 g wood weight for each barrel or a ratio of 760. Therefore, the efficiency of transfer of aromatic components of the wood into wine is a highly inefficient process.

Considering that the quantity of aromatic compounds extracted from wood is very small, it is conceivable to achieve the same quality of wine from 71 g of oak wood ground to a radius of about 100 microns and allowed to equilibrate with the wine over the same period of time as it takes for the wine to age in a barrel. However, as the amount of wood is increased, the aging time would be reduced proportionally.

Thus to achieve a standard one year of aging in one month, a total of about 830 g of wood would be needed for a barrel-full of wine. This method does not alter the partition coefficient of transfer of aromatic components and thus allows the wine to age in a natural progression.

The mass transfer involved in the aromatization of wine aged in wood barrels is controlled by the mass transfer coefficient which is described in the Fick's laws.

Fick's first law relates the diffusive flux to the concentration field, by postulating that the flux goes from regions of high concentration (thermodynamic activity) to regions of low concentration, with a magnitude that is proportional to the concentration gradient (spatial derivative). In one (spatial) dimension, this is

$$J = - D \frac{\partial φ}{\partial x}$$

where:
J is the diffusion flux in dimensions of amount of substance, length⁻² time⁻¹] and measures the amount of substance that will flow through a small area during a small time interval.

Flux=−P·A·(c₂−c₁), in which
P is the permeability, an experimentally determined membrane “conductance” for a given gas at a given temperature.
A is the surface area over which diffusion is taking place.
c₂−C₁ is the difference in concentration of the gas across the membrane for the direction of flow (from c₁ to c₂).
D is the diffusion coefficient or diffusivity in dimensions of [length² time⁻¹],
Φ (for ideal mixtures) is the concentration in dimensions of [(amount of substance) length⁻³],
X is the position [length].

The driving force for the one-dimensional diffusion is the quantity, which for ideal mixtures is the concentration gradient. In chemical systems other than ideal solutions or mixtures, the driving force for diffusion of each species is the gradient of chemical potential of this species.

A comparison of flux is provided below comparing the transport of volatile and other substances from the wood core to the aging wine. It is noteworthy that a sink condition or the concentration in the wine is considered negligible; the permeability coefficient is the same since no change in temperature or the dielectric constant of the extracting media is imposed, leaving only one parameter as a variable, the surface area.

In standard aging of wines and spirits, the flux is restricted to 0.13 cm-square per mL of alcoholic beverage. A increase in this factor would proportionally reduce the time taken for aging. For example, if wine is aged for three years then we have a factor of 0.13 sq-cm/mL/1,095 days or 0.13×1,095=142.35 sq-cm for achieving the same total flux in one day. Comparing the aging of 223 Liters, the total come to 142.3×223,000=31,744,050 sq-cm. Given that wood powder with average diameter of 0.1 mm (100 microns) has surface area of 0.00126 cm², we will need about 25.19 Billion particles; given that we have 0.32 million particles of wood per gram, we will need a total of 77 kg of wood particles; this is a rather impractical limit. However, to achieve an aging of one year in one month, the total amount of wood needed is about 0.7 Kg of wood. The Table below demonstrates this calculation:

| Aging system with 223 L | Fine wood | Relative | |
|---|---|---|---|
| of alcoholic beverage | powder, | Surface | Time to age for 3 |
| aged | (100μ), g | Area | years. |
| Oak barrel | 0.00 | 1 | 3 years |
| Non-wood container | 70 g | 1 | 3 years |
| Non-wood container | 700 g | 10 | 3.65 months |
| Non-wood container | 7000 g | 100 | 10.95 days |

Testing for aging of wine has recently been relegated to electronic systems. For example, an electronic nose (e-nose) based on thin film semiconductor sensors has been developed in order to compare the performance with a trained human sensory panel. The panel had 25 members and was trained to detect concentration thresholds of some compounds of interest present in wine. Typical red wine compounds such as ethyl acetate and eugenol and white wine compounds such as hexanol and ethyl octanoate were measured at different concentrations starting from the detection threshold found in the literature (in the micrograms to milligrams per liter range). Pattern recognition methods (PCA and neural networks) were used to process the data. The results showed that the performance of the e-nose for threshold detection was much better than the human panel. The compounds were detected by the e-nose at concentrations up to eight times lower than the panel. [Comparison between an electronic nose and a human sensory panel for wine compound detection, Santos, J. P. Lozano, J. Aleixandre, M. Arroyo, T. Cabellos, J. M. Gil, M. del Carmen Horrillo, M. Instituto de Fisica Aplicada, Sensor 2004, Proceedings of IEEE, Issue Date: 24-27 Oct. 2004, On page(s): 341-344 vol. 1; Print ISBN: 0-7803-8692-2; INSPEC Accession Number: 8471201; Digital Object Identifier: 10.1109/ICSENS.2004.1426172]. A variety of commercial instruments fully validated are available to monitor aging of wine and these include, Alpha M.O.S. (http://www.alpha-mos.com/home.html), and E-nose Pty Ltd (http://www.e-nose.info/). It is now possible to continuously monitor the saturation of wine with aromatic components establishing the norms of aging without depending on subjective evaluation.

The instant invention shows surprising results by an unexpected modulation of several factors associated with aging of alcoholic beverages. Demonstrated above is the observation that by applying the Fick's first law, the mass transfer of aromatic and non-aromatic components in wood is only dependent on the quantity of these components in the wood and the surface area of wood since the concentration in the alcoholic beverage is near sink condition. Thus by increasing the surface area of contact would be desirable; however, there is no way possible to predict the behavior of this mass transfer based on understanding of any obvious phenomenon. The instant invention reports that unless the particle size is reduced to below 1 mm in diameter, significant mass transfer is not affected in short time.

The instant invention also defines what is considered faster aging and claims that the process of transferring aromatic and non-aromatic components from wood can be achieved within 1-365 days if adequate quantity of wood is added, ranging between 0.1 to 300 G/L.

The instant invention also discloses the value of wet-milling wood chips with alcoholic beverage to capture the aromatic components as they arise out of wood when it is milled whereby the impact of chopping blades raises the temperature of wood particles.

The instant invention also discloses the value of keeping the temperature of alcoholic beverage at less than 25° C. to achieve optimal results; the ideal temperature would be less than 20° C.

The instant invention also discloses the need to keep wood chips frozen prior to their pulverization as they turn brittle and are easier to grind.

The instant invention also discloses the value of reducing oxidation by replacing the headspace with an inert gas such as nitrogen to prevent degradation of the components of alcoholic beverages.

The instant invention also discloses a method of contacting finely divided wood powder with alcoholic beverages by passing them through a percolating vessel containing a support base comprising glass marbles to avoid crumbling of the powder.

The instant invention also discloses a method of instantly aging wine for immediate use whereby an alcoholic beverage is passed through a column containing finely divided wood powder with a support system to avoid collapsing the column.

### Example 1

### Aging by Mixing in a Vessel

Brewed vintage wines were obtained from Don Quixote Distillery & Winery (http://www.dqdistillery.com/Wines_MP.html) and included a Manhattan Project Red Cabarnet as an example of brewed wine and City Cabarnet Cabarnet Savignon as an example of aged wine. To each bottle of brewed wine, 10 g of ground French Oak wood obtained from World Cooperate (http://www.worldcooperage.com/) to particle diameter less than 100 micron by passing through a Fitzmill blade forward and screening through a 140-mesh screen was added and the bottle allowed to rotate on a Wheaton Top Roller (http://www.coleparmer.com/catalog/product_view.asp?sku=29300) for 24 hours; the wines were testing using E-nose equipment. It was discovered that in less than 24 hours, the profile of aromatic components of the brewed wine mixed with 10 g of finely powdered French Oak compared to that of the aged wine supplied by the same manufacturer.

A commercial manufacturing system is described in FIG. 1. The alcoholic beverage-aging vessel is generally of a size of about 10,000 L and would normally contain 30-300 Kg of finely powdered wood to achieve aging ranging between 10 times to 100 times faster. A batch of whisky that takes 12 years to mature can be aged in about 45 days and a wine requiring five years of aging can be aged in about three weeks. While the estimates provided are guideline, it is to be recognized that each fermented alcoholic beverage has a unique characteristics and it would be best to monitor the aging through organoleptic means and to continue aging until such time that the desired characteristics are achieved.

### Example 2

### Perfusion System

A perfusion device was constructed out of PVC pipe of 3 inch diameter; it was capped at both ends with a nipple to attach hose; the pipe was filled with fine powdered wood of size less than 0.1 mm and unaged wine was pumped through one end and removed at other end and recycled through the pipe for periods ranging from 10 minutes to 10 hours; a gradual change in the flavor and taste of wine was observed within the test period. The volume of wine was set equal to the volume of wine that would fill the pipe containing wood powder. In another test, the PVC pipe was filled with glass marbles of standard diameter of ⅝ inches, fine wood powder was filled into the crevices by vibrating the tube; it was observed that almost 75% of volume of the tube is filled with glass marbles, thus four tubes were attached in series to increase the capacity of wine to same volume as one tube without any glass marbles added. Remarkable change in the flavor and aroma of the wine was recorded within one hour of recirculation and optimal results were obtained within one day of recycling the wine through these four tubes.

A commercial system is described in FIG. 2 wherein a bed of fine wood powder contained in a large container to accommodate 300 Kg of wood powder is perfused with alcoholic beverage and the drained beverage through a filter is re-circulated in the container until a desired aroma and flavor has been reached; this system would be suitable for batch size of about 10,000 L of alcoholic beverage.

### Example 3

### Instant Aging by Filtration Process

A filtration device was made by gluing (epoxy) two Whatman No. 3 (1003-125 Grade 3 circles, 125 mm) filter papers after placing 50 g of powdered ground toasted French Oak wood obtained from World Cooperate (http://www.worldcooperage.com/) to particle diameter less than 100 micron by passing through a Fitzmill blade forward and screening through a 140-mesh screen was inserted between two filter papers. After drying, the filter was placed on a 125 mm Buchner funnel of a capacity of 1 L with a stopcock. Contents of an unaged Carbarnet Sauvignon wine were poured into Buchner funnel and kept standing in the funnel for 10 minutes when the stopcock was opened and the wine was collected in a decanter, which was allowed to stand for another 10 minutes prior to tasting; the control testing was done with unaged wine. Remarkable change in the taste, aroma and flavor of wine was noted comparable to an aged sample of wine.

A commercial system is shown in FIGS. 3 and 4; this would typically be of a Buchner funnel wherein a filter such as 125 mm size comprising a pouch that contains about 100 G of fine wood powder would be affixed to the bottom and retained by a rubber or plastic “O” ring; the alcoholic beverage is poured after closing the drain outlet and after a few minutes the drain outlet opened for the beverage to slowly pass through the filter; the beverage inlet tube can be optionally attached to a system to supply air to pressurize the beverage to make it run through the filter faster. Generally, this system would become part of a decanter system used at the point of consumption.

### BRIEF DESCRIPTION OF DRAWINGS

FIG. 1 shows a cross-section of an alcoholic beverage aging vessel comprising 1: gas exhaust; 2: stopcock to control gas exhaust; 3: motor to drive mixing blades; 4: size-reduction mill; 5: stopcock for transfer of powdered wood; 6: gas inlet; 7: stopcock to control gas inlet; 8: top lid; 9: inert gas; 10: container; 11: alcoholic beverage; 12: find wood powder; 13: stirring shaft; 14: stirring blade; 15: stopcock for drain; 16: drain.

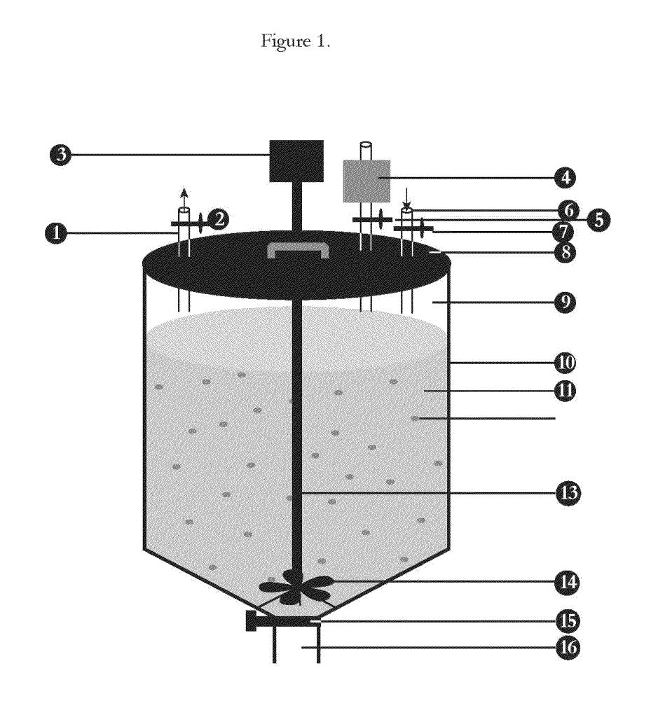

FIG. 2 shows a cross-section of an alcoholic beverage aging vessel comprising 1: top cover; 2: return tube; container; 4: fine wood powder; 5: bottom cover; 6: peristaltic pump; 7: drain stopcock.

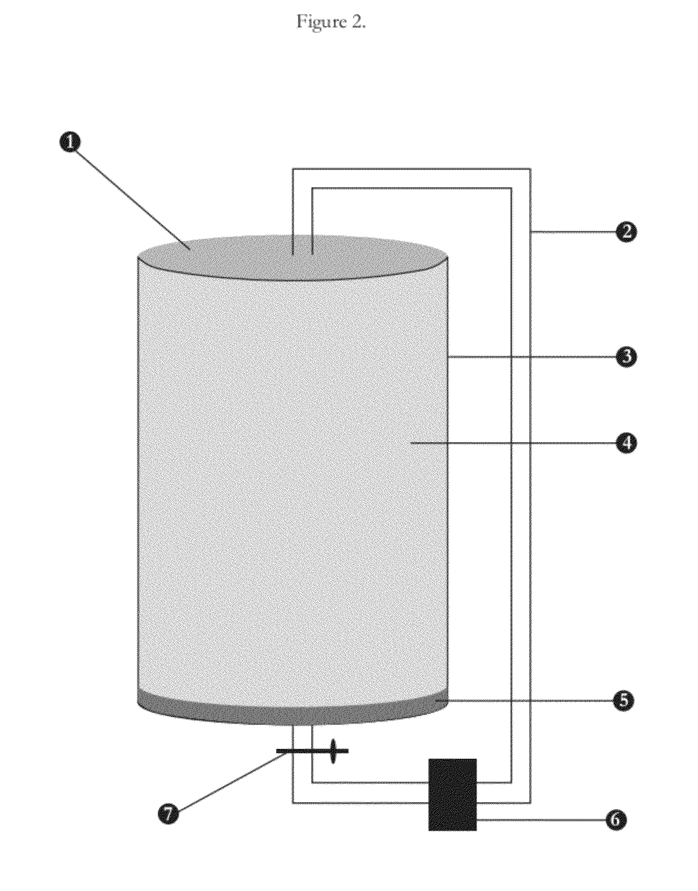

FIG. 3 shows a cross-section of alcoholic beverage aging vessel as depicted in FIG. 2 with addition of glass marbles (8) to prevent collapsing of fine wood powder bed.

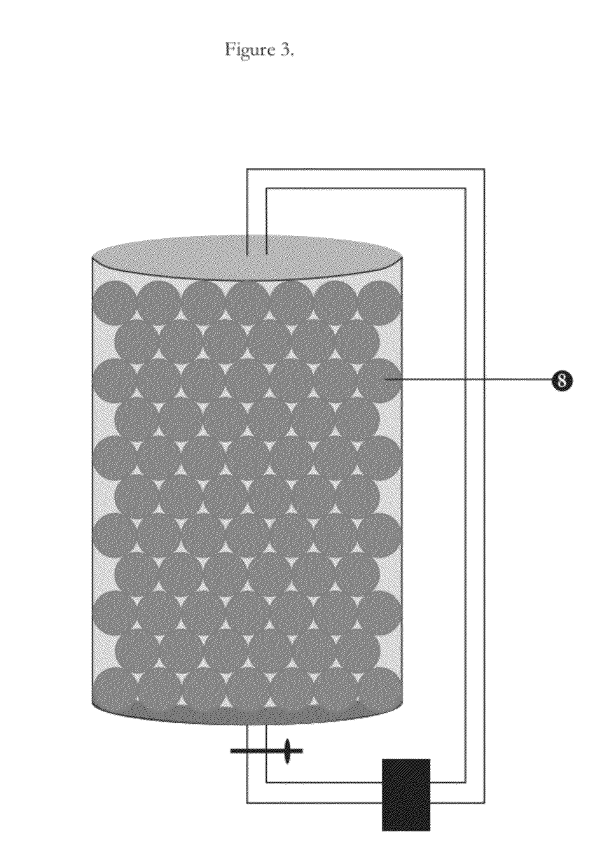

FIG. 4 shows a cross section view of an alcoholic beverage aging vessel comprising 1: beverage and air inlet; 2: top cover; 3: container; 4: alcoholic beverage; 5: sealing “O” ring; 6: filter; 7: perforated support surface; 8: stopcock for drain outlet; 9: drain.

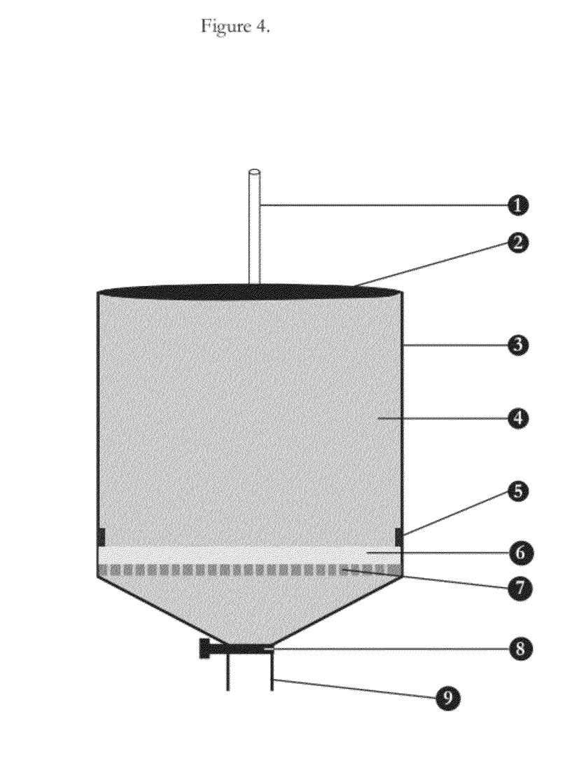

What is claimed is:

1. A method of aging an alcoholic beverage comprising contacting said alcoholic beverage with fine wood powder of particle size smaller than 1 mm in diameter for sufficient length of time to impart desirable flavor and aroma to said alcoholic beverage.

2. The method of claim 1 wherein the particle size of said fine wood powder is smaller than 0.5 mm in diameter.

3. The method of claim 1 wherein the particle size of said fine wood powder is smaller than 0.1 mm in diameter.

4. The method of claim 1 wherein the quantity of fine wood powder used ranges between 0.3 g to 300 g per liter of the volume of said alcoholic beverage being aged.

5. The method of claim 1 wherein said alcoholic beverage is kept at a temperature between 20° C. and 25° C.

6. The method of claim 1 wherein said fine wood powder is freshly prepared.

7. The method of claim 1 wherein said fine wood powder is prepared from a frozen wood.

8. The method of claim 1 wherein said fine wood powder is prepared from wood selected from a group of woods consisting of oak, chestnut, mulberry, cherry, ash and juniper.

9. The method of claim 1 wherein said wood is a combination of two or more woods from a group of woods consisting of oak, chestnut, mulberry, cherry, ash and juniper.

10. The method of claim 1 wherein said wood is toasted.

11. The system of claim 1 wherein said fine wood powder is reused.

12. The method of claim 1 wherein said fine wood powder is removed from said alcoholic beverage by filtration upon completion of said contact period.

13. The method of claim 1 wherein said alcoholic beverage is contacted with said fine wood powder in a vat equipped with a means of mixing comprising a stirring rod.

14. The method of claim 13 wherein said vat has a shape selected from a group of shapes consisting of cylinder, rectangle and sphere.

15. The system of claim 13 wherein said vat is made of a material selected from a group of materials consisting of wood, stainless steel, carbon steel, aluminum, plastic and glass.

16. The method of claim 13 wherein the quantity of said fine wood powder ranges between 3 g to 30 g/L of said alcoholic beverage.

17. The method of claim 16 wherein the aging time is reduced by a factor ranging from 10-100 compared to wood barrel-aging process.

18. The method of claim 1 wherein said alcoholic beverage is contacted with said fine wood by passing through a bed of said fine wood powder.

19. The method of claim 18 wherein said bed comprises a container filled with said fine wood powder.

20. The method of claim 19 wherein said container is a cylinder, rectangle, cube or disc.

21. The method of claim 18 wherein said fine wood powder is mixed with inert beads to prevent collapsing said bed of said fine wood powder.

22. The method of claim 21 wherein said inert bead comprises glass marbles of size ⅝ inch in diameter.

23. The method of claim 19 wherein the quantity of said fine wood powder packed in said container is 1 g to 50 g/L of said alcoholic beverage to be aged.

24. The method of claim 19 wherein said alcoholic beverage is re-circulated through said container for a sufficient period to achieve desired flavor and aroma.

25. The method of claim 20 wherein a plurality of said containers is arranged in a parallel or in series arrangement.

26. The method of claim 20 wherein said container has a shape selected from a group of shapes consisting of cylinder, rectangle, square and disc.

27. The system of claim 20 wherein said container is made of a material selected from a group of materials consisting of wood, stainless steel, carbon steel, aluminum, plastic and glass.

28. A system for contacting said alcoholic beverage with said fine wood powder in a mixing apparatus comprising:
a container having an inner volume, a conical bottom surface, and a drain outlet with a stopcock;
a hermetically-sealable top cover with a beverage inlet with stopcock, a wood powder transfer inlet with a stopcock, a gas inlet with a stopcock, a gas outlet with a stopcock;
a means of agitating said alcoholic beverage in said container comprising a stirring rod inserted through said top cover and operated by a motor external to said container;
a means of pulverizing said wood and introducing it into said container comprising a size reduction mill attached to said fine wood powder transfer inlet;
a means of filtering the contents of said container comprising a filter attached to said drain outlet;
a means of heating or cooling said container;
adding measured quantity of said alcoholic beverage into said container to fill between 50 to 99% of the volume of said container;
adding said wood in quantity ranging between 1.0 to 50 G/L of measured quantity of said alcoholic beverage into said pulverizing mill;
opening said stopcock of said fine wood powder transfer inlet;
operating said size reduction mill to pulverize said wood into said fine wood powder and allowing said fine wood powder to drop into said container through said fine wood powder transfer inlet;
closing said stopcock of said fine wood powder inlet;
opening said stopcock of said gas inlet and said stop cock of said gas outlet;
introducing a quantity of an inert gas equivalent to 2-4 times the estimated volume of head space in said container within 5-15 minutes through said gas inlet;
closing said stopcock of said gas inlet and said stop cock of said gas outlet;
initiating agitation of said alcoholic beverage by starting said stirrer at such speed to create a vortex effect inside said container;
continuing said agitation for a period sufficient to achieve desired flavor and aroma in said alcoholic beverage;
opening said stopcock attached to said drain outlet;
passing said alcoholic beverage through said filter.

29. The system of claim 28 wherein said wood is wet-milled with said alcoholic beverage by introducing said alcoholic beverage into said size reduction mill simultaneously with said wood and operating said size-reduction mill until all said wood has been pulverized and drained into said container, stopping said size-reduction mill and passing balance of said alcoholic beverage through size-reduction mill into said container.

30. The method of claim 28 wherein said inert gas is nitrogen.

31. A system of contacting said alcoholic beverage with said fine wood powder comprising:
a perfusion apparatus comprising:
a cylindrical column with an inner volume;
a first end cap attached to one end and a second cap attached to the other end of said cylindrical column;
said first end cap and said second end cap having a port attached to them;
removing said first end cap and filling said cylindrical column with fine wood powder of particle size smaller than 0.1 mm in diameter;
replacing said first end cap;
Attaching a first tube to said port of said first end cap and connecting said first tube to a reservoir of said alcoholic beverage;
Attaching a second tube to said port of said second end cap and connecting the other end of said second tube to said reservoir of said alcoholic beverage;
attaching a peristaltic pump to said second tube between said second end cap and said reservoir and turning on said peristaltic pump;
continue recycling said alcoholic beverage for sufficient length of time to achieve desired flavor and aroma in said alcoholic beverage.

32. The system of claim 31 wherein a plurality of said perfusion apparatus is connected in either parallel or in series arrangement.

33. The system of claim 31 wherein said perfusion apparatus drains directly into a container for instant drinking.

34. A system of instantly aging said alcoholic beverage comprising:
a filter made of a permeable sac with pores smaller than 0.01 mm;
a container with inner volume, a perforated bottom surface, a bottom drain and a stopcock attached to said bottom drain;
filling said filter with 3-100 G of fine wood powder of particle size less than 0.1 mm in diameter;
placing said filter in said container on top of said perforated bottom surface;
adding 100 mL to 5000 mL of said alcoholic beverage to said container;
allowing said alcoholic beverage to pass through said filter.

35. The system of claim 34 wherein said filter is made of a material selected from a group comprising cellulose, regenerated cellulose, cellulose acetate, cellulose nitrate, polyester, polytetrafluoroethylene, hexamethylenediamine, polyethersulfone, and polypropylene.

36. The system of claim 34 wherein said container is pressurized by first sealing the open end of said container with a closure with a port, attaching said port to a supply of said air and passing said air into said container to increase the rate of filtration.

37. The method of claim 36 wherein a bulb, syringe or a pump supplies air.
